(19) United States
(12) Patent Application Publication
(10) Pub. No.: US 2008/0142525 A1
(43) Pub. Date: Jun. 19, 2008

(54) SECONDARY DRAIN PAN

(76) Inventor: Timothy Donald BROUILLETTE, BEAUFORT, SC (US)

Correspondence Address: COLLARD & ROE, P.C., 1077 NORTHERN BOULEVARD, ROSLYN, NY, 11576, US

(21) Appl. No.: 11/611,950

(22) Filed: Dec. 18, 2006

(51) Int. Cl. F24F 13/22; B01D 53/26; F25D 21/14

(52) U.S. Cl. 220/571; 62/291

(57) ABSTRACT

A secondary emergency condensate drain pan for an HVAC equipment and drains into the secondary pan. The secondary pan is positioned under the entire air handler to catch any water that gets outside the pan and cabinet of the HVAC unit and drains this water out of the structure utilizing standard draining practices. The drain pan is made of molded plastic that is sloped from the four corners inward to the center and down the middle to a threaded hole which its bottom is below the bottom panel, allowing no water to pool in front of the connection. There are a plurality of risers molded in the base and which protrude upward around the four corners to allow the air handler to set in a level manner. The height of the cones allows for duct connections to be made effectively to the air handler. The cones have hollow centers to allow pans to be stacked upon one another. The pan is designed such that the under side has supported ribs to ensure structural integrity. Also the height allows enough pitch for a secondary line to exit the structure.

### BACKGROUND OF THE INVENTION

This invention relates to a one step designed emergency drain pan which catches condensate overflow from an HVAC air handler. It also can be used as a pan for heat pump condensing units that are in concrete court yards or platforms that utilize the space below them for storage. Many owners in southern states in the United States do not like water buildup on their concrete which causes algae growth. Also, these owners do not like water dripping on their storage under the condensing units when they are elevated.

As to the pan being utilized as an air handler emergency drain pan, wherein it allows for the installing dealers to have a one step, one product pan assembly. With standard installation practices, a galvanized pan is set onto plywood or a stand is built of wood to give the unit a little elevation. After the pan is set, the installer has to cut treated 2×4 wood planks the length of the pan, stack two together and nail, and then make one more set and place in the pan. Then the installer sets four rubber vibration isolators on the 2×4's and in turn sets the air handler. Another method is to use foam blocks placed in the pan which take place of the wood. The drain line exiting the galvanized pan has no pitch if placed on the rafters, or the installer has to build a platform to get elevation. One other method is to hang the air handler from a cradle made of threaded rods, 2×4's and angle iron. Once again, the installer has to cut wood to support the secondary drain pan and air handler and continue using previous described methods to set the air handler. The plastic molded drain pan has an elevated bottom and a pitched bottom panel with for example 4.5″ support risers extending upward to allow a level unit. The pitch of the panels ensures no standing water beneath the unit. The older style design using galvanized pans causes about 3-5 gallons of water to sit under the unit as it drains. This in turn causes algae growth, rust and potential problems for a service technician trying to remove the water with vacuums or other means of removal. One type of secondary drain pan is shown in U.S. Pat. No. 6,895,770 to Kaminski filed on Sep. 24, 2003 and issued on May 24, 2005, the disclosure of which is hereby incorporated herein by reference.

### SUMMARY OF THE INVENTION

The present invention allows for easier installation of air handling equipment, a durable long life design, and greater peace of mind for home owners. Because of the one piece design made of injection molded plastic material, the pan has a longer life span than a galvanized pan. Molded plastic also allows for noise reduction transmitting into the structure without using rubber vibration pads. The sloped bottom panel ensures condensate water drains to its lowest place in the pan. At that position, which is in the front middle portion of the pan, water funnels down into the threaded hole which accommodates standard pvc fittings. The threaded hole is designed into a block of plastic below the front edge of the pan. This allows for improved strength so that if someone applies too much pressure to the drain line, the pvc will break and not the side of the pan. A channel leads from the bottom panel down into the block, thus allowing no water to stand at its connection. The four risers built into the pan allow the air handler or condensing unit to sit level above the base support and sloped bottom panel. A four inch base, which is accommodating the solid plastic block for the pvc connection, is made under the bottom panel. The base has perpendicular and parallel ribs running from side to side giving support. Solid blocks are at each line parallel with the four risers allowing a threaded connection to be made accommodating a bolt such as a ½″ bolt. These connections allow for “L” shaped brackets to be installed in front and back panels to hang the pan.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawings, wherein similar reference characters denote similar elements throughout the several views:

FIG. 1A is a top plan view of a drain pan;

FIG. 1B is a bottom plan view of the drain pan shown in FIG. 1A;

FIG. 2 is a side view of the drain pan;

FIG. 3A is a side cross-sectional view of the pan taken along the line I-I;

FIG. 3B is a side cross-sectional view of the pan taken along the line II-II;

FIG. 3C is a side cross-sectional view of the pan taken along the line III-III;

FIG. 3D is a side cross sectional view of the pan taken along the line IV-IV;

FIG. 3E is a side cross-sectional view of the pan taken along the line V-V; and

FIG. 3F is a side cross sectional view of the pan shown in a stacked manner.

### DETAILED DESCRIPTION OF PREFERRED EMBODIMENTS

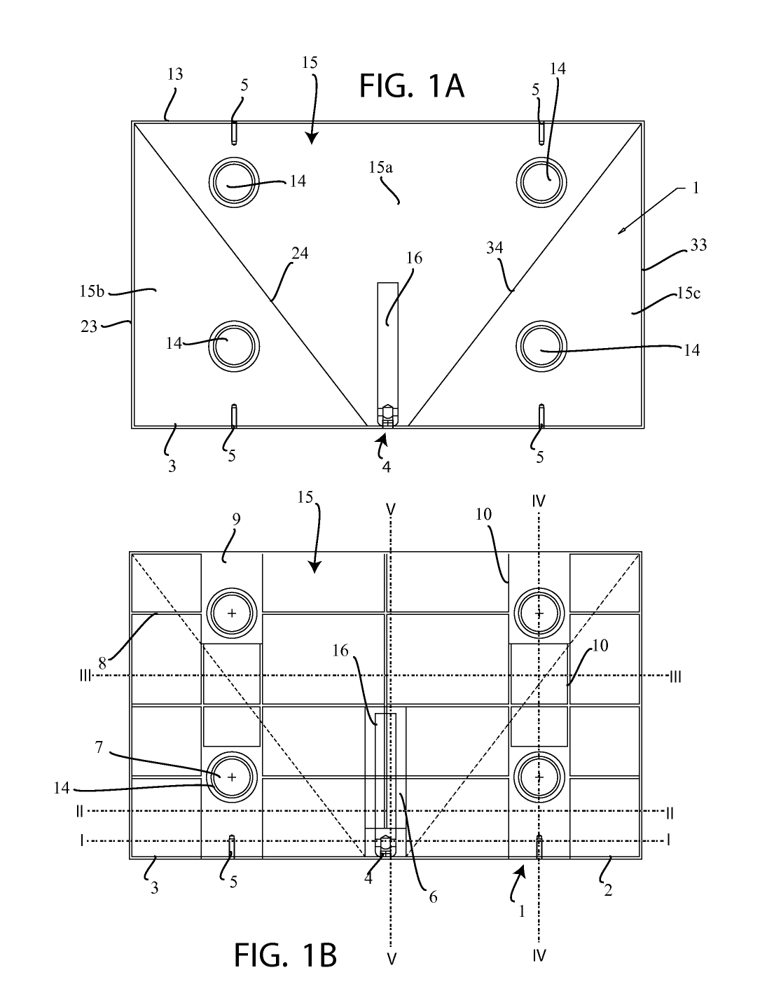

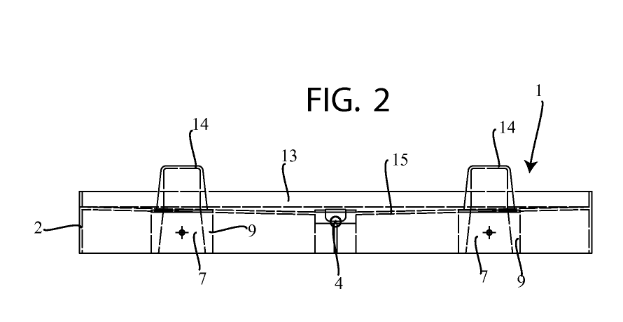

Referring in detail to the drawings, FIG. 1A discloses a top or plan view of a first embodiment of the condensate secondary drain pan assembly 1. In this view, this device includes an outer rim 3 which is coupled to a base 4 (See FIG. 2). There is also a back rim 13 which also extends out from base support 2. This back rim 13, front rim 3, and side rims 23 and 33 all extend up from base support 2 and form a water retaining rim, keeping water within the pan. There is a female threaded connection 4 which can be used to receive any threaded pipe or tube coupled thereto. In addition, there are also screw holes or threaded connection elements 5 which are designed into a side section of the pan.

In addition, there are also a plurality of panels 15, including a first panel 15a, a second panel 15b and a third panel 15c. These panels 15 extend at different angles relative to each other. Extending up from these panels are a plurality of risers 14 wherein these risers 14 allow unit to sit level in this pan 1. These panels 15a 15b and 15c are all angled so that they allow water to flow down through the pan to outlet channel 16 and on to female threaded connection 4. For example, panel 15a is angled at least 1 degree down from back lip 13 to front lip 3. In addition, panel 15b is angled at least 1 degree down from a side lip 23 to angled connection region 24. Similarly, panel 15c is angled at least 1 degree down from side lip 33 to angled connection region 34. These different angled panels, cause the funneling of the water into channel 16, that allows water to drain unimpeded through to threaded connection 4.

FIG. 1B shows a bottom plan view of the device shown in FIG. 1A. For example, there is shown solid blocks 6 and 9. Solid block 6 is formed around channel 16 while solid block 9 is formed around each of the risers 14. Each of the risers 14 includes a hollowed out portion or region 7. In addition, there are ribs 8 which extend across pan 1. These ribs 8 are used for support of panels 15. In addition, there are ribs 10 which are molded with solid blocks 9, as well wherein these ribs 10 are also used for support of panels 15. In this view, there is also shown channel 16 which leads to a female threaded connection 4. In addition, there is also shown threaded connections 5, these threaded connections allow for the connection of angle iron, (2 in front and 2 in back), which allow threaded rods (not shown) to be used to hang the pan assembly without building a cradle. By turning the angle iron down, you can nail or screw the angle to the structure if you are not hanging the unit but allowing it to rest on the rafters or attic flooring. The lip around the top of the drain pan is industry standard height and thickness to allow for an additional float switch to be attached.

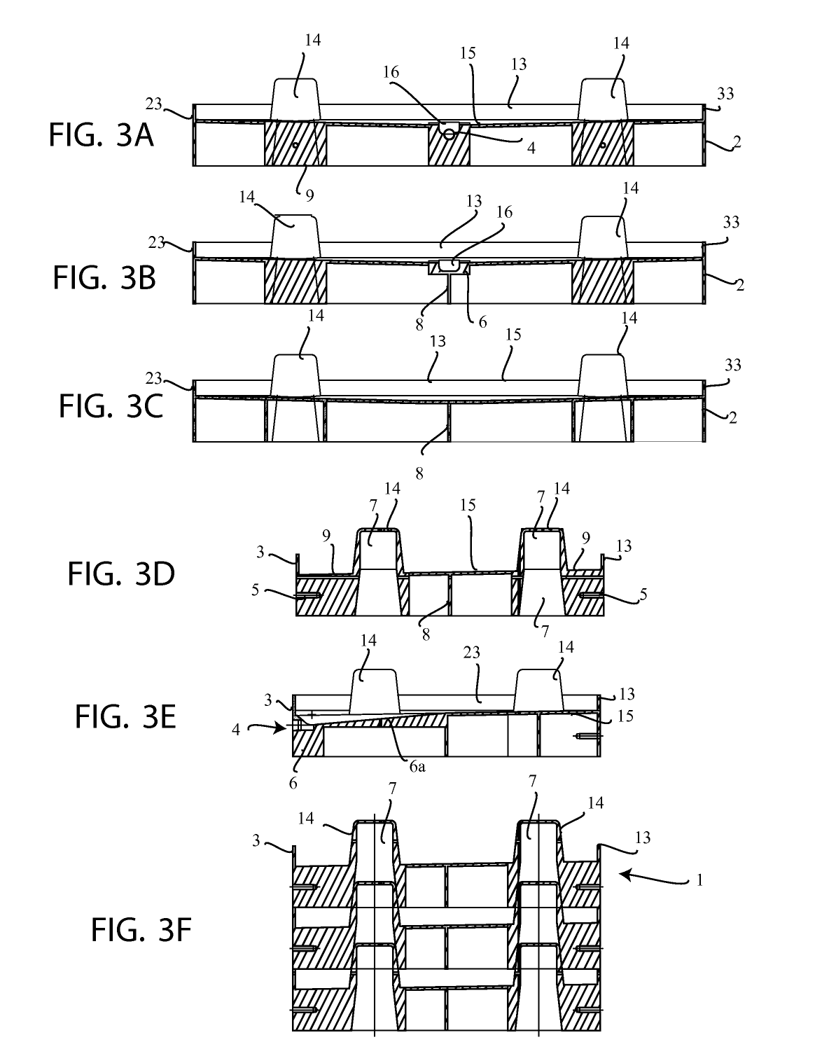

FIG. 2 is a cutaway side view of this device 1. In this view, there are shown risers 14 extending up from panel 15. In addition, there is also shown back lip 13 which extends up from a back face of the device. In addition, there is also shown hollow regions 7 which are cut into blocks 9 and which extend up through risers 14. These hollow regions 7 allow this device to stacked as shown in FIG. 3F.

FIG. 3A, is a side cutaway view taken from the line I-I which shows blocks 9 supporting risers 14. In addition, there is also shown sidewall 13 and also block 6 which is used to support channel 16 which leads into female threaded connection 4. Furthermore, there is also shown a support to which is used to elevate panel 15 above the bottom section. FIG. 3B is a side cutaway version shown in line II-II which also shows lip 23, risers 14 and solid blocks 9. This view also shows a small section of blocks 6 and channel 16. FIG. 3C is a side cross-sectional view take along line III-III which shows ribs 8 extending along the bottom section for reinforcing pan 15. Furthermore, there are risers 14 extending up therefrom and also a back lip 13 extending out from panel 15.

FIG. 3D shows a side cross-sectional view taken along line IV-IV wherein this view shows blocks 9 which has threaded connection 5 and risers 14 including hollow sections 7. There is also shown an side cross sectional view of pan 15 as well is ribs 8 which extend to the substantially perpendicular pan 15. These blocks 9 are shown at either end and each include the threaded connection 5. FIG. 3E discloses a side cross-sectional view taken along the line 5-5, in this view, there's shown solid portion 6 which includes a ramp shaped section 6a creating a channel 16 to extend therethrough. There is also female threaded connection 4 for allowing a tube to be connected thereto. In this view, there are shown a side lip 23 for allowing fluid or water to flow therethrough.

FIG. 3F discloses a side cross-sectional view of pans which are shown stacking one on top of the other. In this view, hollow sections 7 are designed to accommodate risers 14 which fit therein. With this design, risers 14 fit inside of hollow sections 7 allow and four stable stacking of these pans allowing for an easy shipment of this device.

These risers 14 are also positioned so that they extend up from the sloped panels 15 to support elements above the pan 1. In that way, an element or device can be stacked on top so that it would sit level on these risers 14.

Accordingly, while a few embodiments of the present invention have been shown and described, it is to be understood that many changes and modifications may be made thereunto without departing from the spirit and scope of the invention as defined in the appended claims.

What is claimed is:

1. A secondary drain pan comprising:
at least one sloped panel for receiving water;
a plurality of side walls coupled to said at least one sloped panel;
at least one drain formed in at least one of said sloped panel; and
at least one base support for elevating said at least one sloped panel above a ground surface.

2. The pan as in claim 1, wherein said at least one base support is formed as at least one extending spacer for spacing said sloped panel above a ground surface.

3. The pan as in claim 2, wherein said base support is formed as at least one extending rib extending out from said at least one panel.

4. The pan as in claim 1, further comprising at least one reinforcing rib extending out from said at least one sloped panel.

5. The pan as in claim 4, wherein said at least one reinforcing rib is coupled to said base support.

6. The pan as in claim 1, wherein said base support further comprises at least one solid block.

7. The pan as in claim 1, further comprising at least one riser.

8. The pan as in claim 7, wherein said at least one riser is in the form of a frusto-conical spacer element extending out from said at least one sloped panel.

9. The pan as in claim 7, wherein said riser has a hollow section is formed as a hollow spacer element, and such that a plurality of pans can be stacked one on top of the other wherein a riser from a bottom pan can be inserted into said hollow section of said riser.

10. The pan as in claim 1, wherein said at least one sloped panel comprises at least two sloped panels.

11. The pan as in claim 1, wherein said at least one sloped panel comprises at least three sloped panels wherein a first sloped panel extends from a back side wall and slopes down towards said at least one drain, and said second sloped panel extends from a side wall to a region intersecting said first sloped panel, and said third sloped panel extends from a side wall opposite said second sloped panel towards a region intersection said first sloped panel.

12. The pan as in claim 1, wherein said drain further comprises at least one channel that is formed in said at least one sloped panel, wherein said channel is for allowing water to drain from said at least one sloped panel in said pan.

13. The pan as in claim 12, wherein said at least one drain further comprises at least one threaded connection for allowing a threaded pipe to connect thereto.

14. The pan as in claim 1, further comprising at least one connection element disposed in said base support for allowing additional elements to be coupled thereto.

15. The pan as in claim 14, wherein said connection element is in the form of a threaded connection for allowing a threaded element to be coupled thereto.

16. The pan as in claim 1, wherein said at least one drain is positioned at a lowest elevational section of said at least one panel to receive water flow along the panel.

17. The pan as in claim 1, wherein said at least one sloped panel and said side walls are adapted so as to extend beyond a pan positioned above said pan but below a HVAC unit.

18. A secondary drain pan comprising:
at least one sloped panel for receiving water;
a plurality of side walls coupled to said at least one sloped panel;
at least one drain formed in at least one of said sloped panel; and
at least one riser extending up from said sloped panel for supporting elements above said at least one sloped panel.

19. The pan as in claim 18, wherein said at least one sloped panel comprises at least three sloped panels wherein a first sloped panel extends from a back side wall and slopes down towards said at least one drain, and said second sloped panel extends from a side wall to a region intersecting said first sloped panel, and said third sloped panel extends from a side wall opposite said second sloped panel towards a region intersection said first sloped panel.
